(19) United States
(12) Patent Application Publication
(10) Pub. No.: US 2016/0216756 A1
(43) Pub. Date: Jul. 28, 2016

(54) POWER MANAGEMENT IN COMPUTING DEVICES

(71) Applicants: Wei YANG, Minhang, Shanghai (CN); Chao XU, Minhang, Shanghai (CN); Debing ZHENG, Minhang, Shanghai (CN); Yuhong CHEN, Minhang, Shanghai (CN); Christopher RUESGA, Chandler, AZ (US); INTEL CORPORATION, Santa Clara, CA (US)

(72) Inventors: Wei Yang, Shanghai (CN); Chao Xu, Shanghai (CN); Debing Zheng, Shanghai (CN); Yuhong Chen, Shanghai (CN); Christopher Ruesga, Chandler, AZ (US)

(21) Appl. No.: 14/916,853

(22) PCT Filed: Nov. 29, 2013
(86) PCT No.: PCT/CN2013/088155

§ 371 Date: Mar. 4, 2016

(51) Int. Cl. G06F 1/32

(52) U.S. Cl. CPC G06F 1/3287; G06F 1/3275; G06F 1/3237

(57) ABSTRACT

Various techniques for modifying an operating state of a processor are described herein. In one example, an electronic device includes logic that can determine that a processor cannot modify the operating state of the processor. In some embodiments, the logic can also detect an indication that the electronic device is to enter an idle state and store state information from the processor in a volatile memory device. The logic can also cause the processor to enter the idle state.

### CROSS-REFERENCED TO RELATED APPLICATION

This application is a U.S. National Stage Application of International Patent Application PCT/CN2013/088155 filed Nov. 29, 2013, the contents of which are incorporated by reference as if set forth in their entirety herein.

### TECHNICAL FIELD

The present techniques relate generally to power management in computing devices and more particularly, but not exclusively, to reducing power consumption in computing devices.

### BACKGROUND ART

Reducing power consumption in electronic devices has generally been handled with a two-tiered scheme. Systems and sub-systems generally consisting of multiple integrated circuit chips (ICs), interconnected by printed circuit boards and various connectors and cables, enabled individual single-function ICs to be operated at a standby voltage or be completely powered off to conserve power. For example, memory ICs might operate at a significantly different voltage than a processor, or network controllers might have different power needs than the physical layer transceivers, etc. However, as IC fabrication techniques have advanced, the functions once performed by multiple and separate ICs may now be performed by an embedded portion of a more complex IC, such as a system-on-chip IC (SoC).

### BRIEF DESCRIPTION OF THE DRAWINGS

FIG. 1 is a block diagram of an example of a computing system that can modify the operating state of a processor;

FIG. 2 is a block diagram illustrating example modes of operation of an electronic device that can modify the operating state of a processor;

FIG. 3 is a block diagram illustrating the execution sequence of an example embodiment for modifying the operating state of a processor; and

FIG. 4 is an example block diagram of a method for modifying an operating state of a processor.

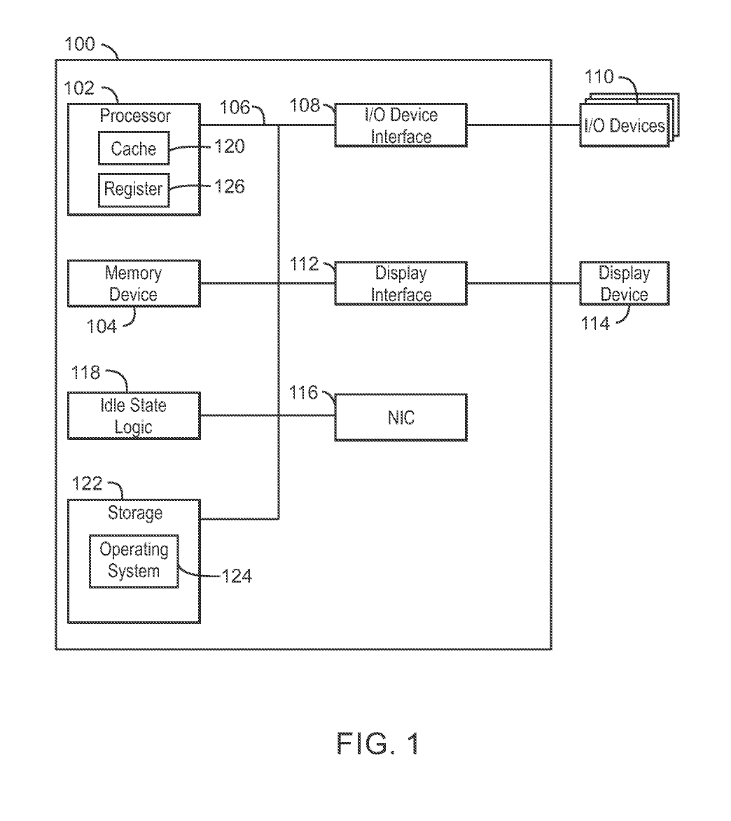

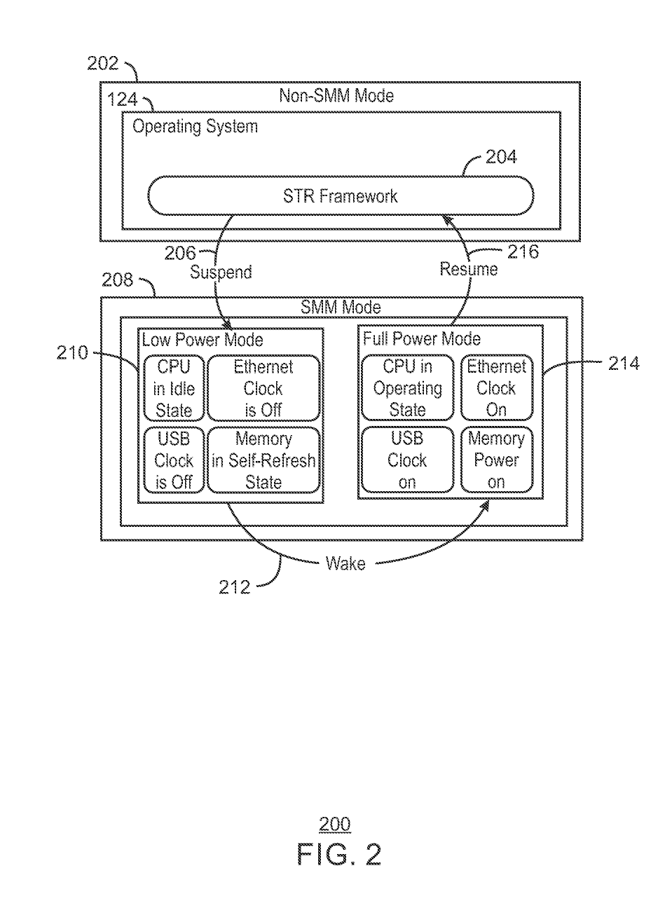

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Within a system on a chip, all functions have traditionally been powered at the same voltage level and, for the most part, at a single operating or clock frequency. Power management was limited to gating clocks to turn off inactive functions in order to conserve power. For example, an input-output controller IC may be able to turn off certain interfaces that have no devices currently connected to them. A disadvantage of the above-described approach is that it does not permit fine-grained control of individual functions within a chip. With the increasing popularity of SoC devices, many of the functions that used to reside in separate chips are integrated into one chip thereby making it difficult or impossible to gate the clock or reduce the operating voltage of the SoC chip. The concept of power islands (also known as voltage islands) provides the benefit of operating different areas or functions of a single chip at different and independent voltage levels and clock frequencies. For example, a chip may be designed with separate power islands for memory, input/output and processor functions. Although many chip designs could benefit by implementing power islands, design and development of such chips require extensive resources. Moreover, many chips include shared devices, such as, for example, shared input/output (I/O) devices, that are utilized by other devices or functions on the same chip, and such shared devices cannot be shut down independently thereby reducing the benefit derived from implementing power islands in such designs.

The suspend to random access memory (Suspend to RAM or STR) technology may also be utilized by systems to reduce power consumption. Generally, STR technology powers off the functions of a chip except for main memory, which is placed in a low power self-refresh operating mode, and devices/functions that may produce wake events. However, chips without power islands and chips with shared I/O devices derive very little if any benefit in terms of reduced power consumption from STR technology. Thus, reducing power consumption in chips that do not implement power islands and chips that include shared devices is challenging.

According to embodiments described herein, logic in a computing device can detect that a processor within the computing device does not support various idle states (also referred to herein as C states). For example, a processor may not support functionality of the advanced configuration and power interface specification (also referred to herein as ACPI). An idle state, as referred to herein, can include any suitable state of a processor in which the power consumption of the processor is lower than the power consumption in the operating state. For example, an idle state may include any state in which a processor does not receive power to any suitable number of components within the processor. An operating state, as referred to herein, can include any state in which the processor maintains full power and can execute instructions using any suitable number of components within the processor. In some examples, logic can modify the operating state of the processor by transitioning to an idle state. For example, logic may store any suitable state information for the processor in memory within the processor and reduce power consumption of the processor by stopping the clock signal to any suitable number of components within a processor or modifying the frequency at which a processor executes instructions. In some examples, the memory within the processor can enter a self-refresh state to prevent data loss within the memory.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an example of a computing system that can modify the operating state of a processor. The computing device (also referred to herein as electronic device) 100 may be, for example, a computing phone, laptop computer, desktop computer, or tablet computer, among others. The computing device 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory, read only memory, flash memory, or any other suitable memory systems. The instructions that are executed by the processor 102 may be used to implement a method that can modify the operating state of a processor.

The processor 102 may be connected through a system interconnect 106 (e.g., PCI®, PCI-Express®, etc.) to an input/output (I/O) device interface 108 adapted to connect the computing device 100 to one or more I/O devices 110. The I/O devices 110 may include, for example, a keyboard and a pointing device, wherein the pointing device may include a touchpad or a touchscreen, among others. The I/O devices 110 may be built-in components of the computing device 100, or may be devices that are externally connected to the computing device 100.

The processor 102 may also be linked through the system interconnect 106 to a display interface 112 adapted to connect the computing device 100 to a display device 114. The display device 114 may include a display screen that is a built-in component of the computing device 100. The display device 114 may also include a computer monitor, television, or projector, among others, that is externally connected to the computing device 100. In addition, a network interface controller (also referred to herein as a NIC) 116 may be adapted to connect the computing device 100 through the system interconnect 106 to a network (not depicted). The network (not depicted) may be a cellular network, a radio network, a wide area network (WAN), a local area network (LAN), or the Internet, among others.

The processor 102 may also be linked through the system interconnect 106 to idle state logic 118 (also referred to herein as a power management unit or P-unit). In some embodiments, the idle state logic 118 can modify an operating state of the processor 102. For example, some processors such as the Intel Atom®, among others, may not support idle states. As discussed above, an idle state can include any suitable state of a processor in which the processor consumes less power than in an operating state. For example, an idle state may include removing power to a clock signal for any suitable number of components within the processor 102. The ide state may also include removing power from any suitable number of volatile memory devices, also referred to as cache devices 120, located within the processor 102. In some embodiments, the idle state logic 118 can indicate to the processor 102 to transition the cache devices 120 to a self-refresh state. Processors 102 that cannot support idle states may not include the functionality to reduce supply voltage to, or otherwise power gate, individual functional areas of the processor 102. In some embodiments, the idle state logic 118 can also modify the operating state of shared devices in the computing device 100 such as the I/O device interface 108.

The processor 102 may also be linked through the system interconnect 106 to a storage device 122 that can include a hard drive, an optical drive, a USB flash drive, an array of drives, or any combinations thereof. The storage device 122 may store data retrieved from the processor 102 by the idle state logic 118. In some embodiments, the storage device 122 may also store an operating system 124 that can include functionality to implement the Advanced Configuration and Power Interface (ACPI) specification and the operating system power management (OSPM). In some embodiments, the operating system 124 can indicate that the computing device 100 is to enter an idle state, such as suspend-to-ram, among others. In some examples, the idle state logic 118 can detect the indication to modify the operating state of a processor 102 to an idle state by monitoring a register 126. For example, the processor 102 may receive an instruction from the operating system 122 and the output of the instruction may be stored in the register 124. In some embodiments, the idle state logic 118 can use techniques such as power gating to modify the power consumption of the processor 102 during idle states. For example, the idle state logic 118 may transition the processor 102 to a reset state.

It is to be understood that the block diagram of FIG. 1 is not intended to indicate that the computing device 100 is to include all of the components shown in FIG. 1. Rather, the computing device 100 can include fewer or additional components not illustrated in FIG. 1 (e.g., additional memory components, embedded controllers, additional modules, additional network interfaces, etc.). Furthermore, any of the functionalities of the idle state logic 118 may be partially, or entirely, implemented in hardware and/or in the processor 102. For example, the functionality may be implemented with an application specific integrated circuit, in the logic implemented in an I/O device 110, logic implemented in an embedded controller, or logic implemented in a microcontroller, among others. In some embodiments, the functionalities of the idle state logic 118 can be implemented with logic, wherein the logic, as referred to herein, can include any suitable hardware (e.g., a processor, among others), software (e.g., an application, among others), firmware, or any suitable combination of hardware, software, and firmware.

FIG. 2 is a block diagram illustrating example modes of operation of an embodiment of an electronic device that can modify the operating state of a processor such as the computing device 100 of FIG. 1. In some embodiments, the computing device 100 may operate in a non-system management mode 202, in which the operating system 124 may not modify the operating state of a processor. In some embodiments, the operating system 124 can include a suspend-to-ram (also referred to herein as STR) framework 204. The operating system 124 may receive a request, such as an interrupt or other signal, to enter an idle state such as the STR operating mode.

In some embodiments, the operating system 124 may also generate an instruction or call 206 to enter the system management mode 208. In the system management mode 208, the idle state logic 118 can detect the instruction or call to enter the system management mode 208 and modify the operating state of any suitable number of components such as the processor, ethernet or network interface, universal serial bus interface and memory devices, among others. In some examples, the idle state logic 118 may monitor a register that indicates whether to modify the operating state of a component. For example, the idle state logic 118 may enter a low power mode 210 wherein a processor is placed in an idle state that reduces power consumption. In some examples, the idle states can correspond to processor states C0, C1, C2, C3, C4, C5, C6, or C7 as defined by the ACPI specification and/or any other suitable specification. In low power mode 210, the clock signals of components, such as the ethernet port and the universal serial bus, among others, may be gated, transitioned to a reset state, or turned off. In some examples, memory devices can be transitioned to a self-refresh mode. In some embodiments, the processor may be an ARM-type processor and the memory devices may not be transitioned to a self-refresh mode.

In some examples, the idle state logic 118 may detect a wake event 212, wherein the computing device enters a full power mode 214. In some embodiments, the full power mode 214 includes modifying the processor from an idle state to an operating state, and returning power to the clock signals for any suitable number of components such as the ethernet port, universal serial bus, and memory, among others. The idle state logic 118 can then indicate 216 to the compliant operating system 124 to resume normal operation.

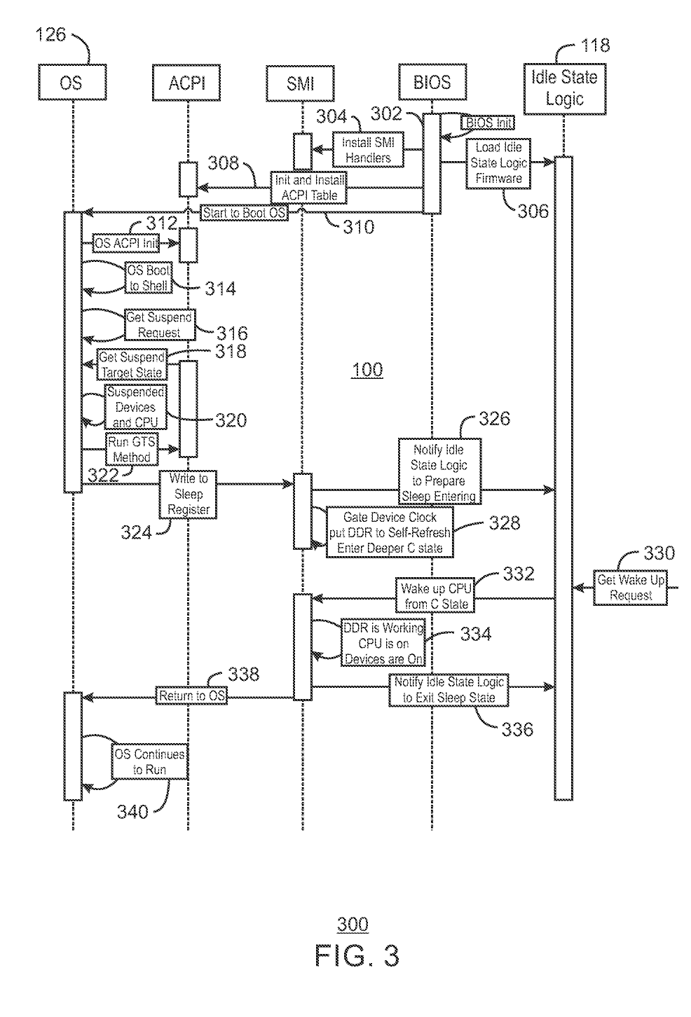

FIG. 3 is a block diagram illustrating the execution sequence 300 of an example embodiment for modifying the operating state of a processor. At 302, the BIOS of computing device 100 is initialized. In some embodiments, the BIOS can be initialized each time a computing device is restarted or receives power. At 304, the system management interface (also referred to herein as SMI) handlers are installed by the BIOS. In some embodiments, the SMI handlers can notify the idle state logic 118 that the operating state of a processor is to be modified.

At 306, the firmware, which includes instructions for modifying the operating state of a processor, are loaded into the idle state logic 118. At 308, the advanced configuration and power interface (ACPI) table is initialized and installed in the ACPI unit. In some embodiments, the ACPI table can indicate the voltages and frequencies that correspond with any suitable number of idle states and operating states for a processor.

At 310, the BIOS initiates booting of the operating system 124. At 312, the operating system 124 initializes the ACPI unit, and at 314 the operating system 124 boots to the operating shell. At 316, a suspend to ram or STR request is received by the operating system 124. At 318, the ACPI provides to the operating system 124 the suspend target state and at 320 the devices and a processor of electronic device 100 are suspended. At 322, the go to sleep method is executed. At 324, the operating system 124 writes a predetermined value to a register or sets a flag. The SMI at 326 notifies the idle state logic 118 that the electronic device 100 is entering the sleep or suspend to ram mode. At 328, the SMI gates the clock signals of the controllable devices within electronic device 100, including, for example, I/O devices 110, causes the memory 104 to enter a self-refresh mode, and causes processor 102 to enter an idle state.

At 330, a wake up request is received by the idle state logic 118. At 332, the idle state logic 118 sends a wake-up request to a processor to return to an operating state from the idle state. At 334, the memory device exits the self-refresh mode to return to a fully powered mode, the processor exits the idle state, and any other devices which were powered off are powered on. At 336, the SMI notifies the idle state logic 118 to exit the sleep or suspend to ram mode, and at 338 control of the operation of electronic device 100 is returned to the operating system 124. At 340, the operating system 124 enters into and continues normal operation.

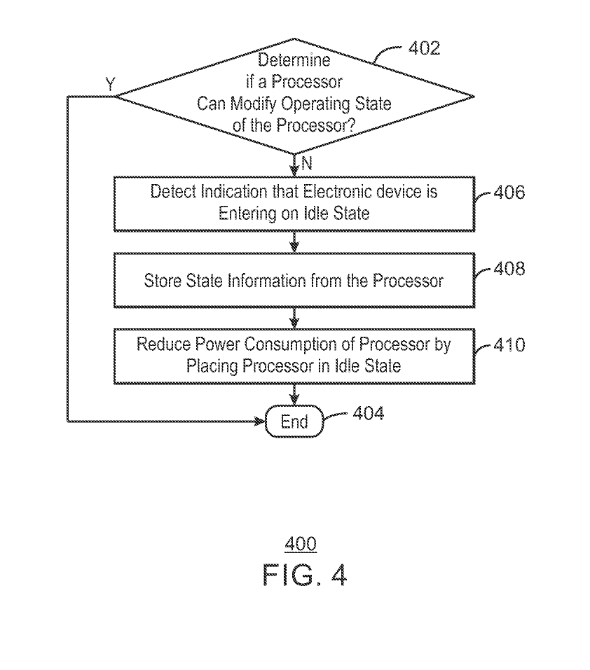

FIG. 4 is an example block diagram of a method for modifying an operating state of a processor. The method 400 can be implemented with any suitable computing device, such as the computing device 100 of FIG. 1.

At block 402, the idle state logic 118 can determine that the processor cannot modify the operating state of the processor. In some embodiments, a processor may not support or recognize instructions that implement idle states specified by the advanced configuration and power interface specification. For example, a processor, such as the Intel Atom®, may support an operating state that includes full power to the processor or the processor may be turned off. In some examples, the processor may not support functionality that can modify the power consumption of the processor in idle states. As discussed above, idle states can include any suitable number of states that reduce the power consumption of a processor. For example, a halt idle state (also referred to as C1) may not execute instructions within the processor and the latency period for returning the processor to executing instructions may be small. In some examples, the processor may not provide power to volatile memory devices such as cache devices located within the processor.

If the idle state logic 118 determines that the processor can modify the operating state of the processor, the process flow ends at block 404. If the idle state logic 118 determines that the processor cannot modify the operating state of the processor, the process flow continues at block 406.

At block 406, the idle state logic 118 can detect an indication that the electronic device is entering an idle state. In some embodiments, the idle state logic 118 can receive the indication from an operating system that indicates a processor is to enter an idle state. In some embodiments, the operating system can also indicate one of various idle states the processor is to use for execution. For example, a processor may transition from an operating state of full power to a halt state that reduces the power consumption of the processor, among others.

At block 408, the idle state logic 118 can store state information from the processor in a memory device. In some examples, the memory device may reside within the processor. State information, as referred to herein, can include any suitable data used during executing instructions within a processor. For example, the state information may indicate the location of instructions to be executed within a memory device, any suitable number of output values, and the like. In some embodiments, the idle state logic 118 can transfer data stored in a volatile memory of the processor to a non-volatile memory device to enable the processor to resume an operating state at a later time with current data. For example, a cache storage area in a processor may include any suitable amount of data used for executing instructions within the processor. In some examples, the idle state logic 118 may transfer data from the cache storage area, or any suitable volatile memory device within the processor, to a non-volatile memory device such as flash memory, among others. In some embodiments, the idle state logic 118 can indicate that volatile memory in the processor is to enter a self-refresh state and the data in the volatile memory may not be transferred to a non-volatile memory device.

At block 410, the idle state logic 118 can cause the processor to enter the idle state. For example, the idle state logic 118 may reduce the power consumption of the processor to place the processor in an idle state. In some embodiments, the idle state logic 118 can remove the power to any suitable number of cores or components within the processor. The idle state logic 118 may also remove the power to a system clock signal to some components of the processor. In some embodiments, the idle state logic 118 can also remove the power to any suitable number of components within the processor such as an arithmetic logic unit, or a control unit, among others. Also, the idle state logic 118 may modify the frequency at which the processor executes instructions.

The process flow diagram of FIG. 4 is not intended to indicate that the operations of the method 400 are to be executed in any particular order, or that all of the operations of the method 400 are to be included in every case. Additionally, the method 400 can include any suitable number of additional operations. For examples, in some embodiments, the idle state logic 118 can detect that the processor is to transition from an idle state to an operating state and the idle state logic 118 can retrieve data stored in non-volatile memory from the volatile memory of the processor and store the retrieved data in the volatile memory. Furthermore, in some embodiments, the method 400 can include monitoring data transmitted to the processor for a signal that the processor is to return to the operating state.

### EXAMPLE 1

An electronic device for modifying an operating state of a processor is described herein. In some embodiments, the electronic device includes logic. In some examples, the logic can determine that the processor cannot modify the operating state of a processor. The logic can also detect an indication that the electronic device is to enter an idle state. In addition, the logic can store state information from the processor in a memory device. Furthermore, the logic can cause the processor to enter the idle state.

In some embodiments, the logic can stop a system clock signal within the processor. The logic may also detect the indication that the electronic device is to enter the idle state from an operating system comprising advanced configuration and power interface instructions. In some examples, the idle state comprises a suspend-to-ram state.

### EXAMPLE 2

A method for modifying an operating state of a processor is also described herein. The method can include determining that the processor cannot modify the operating state of the processor. The method can also include detecting an indication that the electronic device is to enter an idle state. In addition, the method can include storing state information from the processor in a memory device. Furthermore, the method can include causing the processor to enter the idle state.

In some embodiments, the processor does not execute instructions during the idle state. Additionally, in some embodiments, the method includes stopping a flow of current to one or more components of the electronic device in response to detecting the indication that the electronic device is entering the idle state. In some examples, the idle state comprises a processor state that consumes less power than the operating state.

### EXAMPLE 3

An electronic device for modifying an operating state is also described herein. The electronic device can include logic. In some embodiments, the logic can detect an indication that the electronic device is to enter an idle state, wherein the idle state reduces the power consumption of a processor. The logic can also determine that the processor cannot modify the operating state of the processor to the idle state. In some embodiments, the logic can also store state information from the processor in a non-volatile memory device and cause the processor to enter the idle state. The logic can also monitor data transmitted to the processor for a signal that the processor is to return to the operating state.

In some embodiments, the logic is to stop a flow of current to one or more components of the electronic device in response to detecting the indication that the electronic device is entering the idle state. In some examples, the processor does not execute instructions during the idle state.

### EXAMPLE 4

An electronic device for modifying an operating state is described herein. In some examples, the electronic device includes means for detecting an indication that the electronic device is to enter an idle state, wherein the idle state reduces the power consumption of a processor. The electronic device can also include means for determining that the processor cannot modify the operating state of the processor to the idle state and means for storing state information from the processor in a non-volatile memory device. In addition, the electronic device can include means for causing the processor to enter the idle state and means for monitoring data transmitted to the processor for a signal that the processor is to return to the operating state.

In some embodiments, the electronic device can also include means for stopping a system clock signal within the processor. The electronic device can also include means for detecting the indication that the electronic device is to enter the idle state from an operating system comprising advanced configuration and power interface instructions.

### EXAMPLE 5

A system comprising a processor and logic are described herein. In some embodiments, the logic can determine that the processor cannot modify the operating state of the processor and detect an indication that the electronic device is to enter an idle state. The logic can also store state information from the processor in a memory device; and cause the processor to enter the idle state. In some embodiments, the system can also include a storage device.

It is to be understood that specifics in the aforementioned examples may be used anywhere in one or more embodiments. For instance, all optional features of exemplary devices described above may also be implemented with respect to any of the other exemplary devices and/or the method described herein. Furthermore, although flow diagrams and/or state diagrams may have been used herein to describe embodiments, the present techniques are not limited to those diagrams or to their corresponding descriptions. For example, the illustrated flow need not move through each box or state or in exactly the same order as depicted and described.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. An electronic device for modifying an operating state comprising:
logic to:
determine that a processor cannot modify the operating state of the processor;
detect an indication that the electronic device is to enter an idle state;
store state information from the processor in a memory device; and
cause the processor to enter the idle state.

2. The electronic device of claim 1, wherein the logic is to stop a system clock signal within the processor.

3. The electronic device of claim 1, wherein the logic detects the indication that the electronic device is to enter the idle state from an operating system comprising advanced configuration and power interface instructions.

4. The electronic device of claim 1, wherein the idle state comprises a suspend-to-ram state.

5. The electronic device of claim 1, wherein the processor does not execute instructions during the idle state.

6. The electronic device of claim 1, wherein the logic is to stop a flow of current to one or more components of the electronic device in response to detecting the indication that the electronic device is entering the idle state.

7. The electronic device of claim 1, wherein the idle state comprises a processor state that consumes less power than the operating state.

8. A method for modifying an operating state of a processor comprising:
determining that the processor cannot modify the operating state of the processor;
detecting an indication that the electronic device is to enter an idle state;
storing state information from the processor in a memory device; and
causing the processor to enter the idle state.

9. The method of claim 8, comprising stopping a system clock signal within the processor in response to detecting the indication that the electronic device is entering the idle state.

10. The method of claim 8, comprising detecting the indication that the electronic device is to enter the idle state from an operating system comprising advanced configuration and power interface instructions.

11. The method of claim 8, wherein the idle state comprises a suspend-to-ram state.

12. The method of claim 8, wherein the processor does not execute instructions during the idle state.

13. The method of claim 8, comprising stopping a flow of current to one or more components of the electronic device in response to detecting the indication that the electronic device is entering the idle state.

14. The method of claim 8, wherein the idle state comprises a processor state that consumes less power than the operating state.

15. An electronic device for modifying an operating state comprising:
logic to:
detect an indication that the electronic device is to enter an idle state, wherein the idle state reduces the power consumption of a processor;
determine that the processor cannot modify the operating state of the processor to the idle state;
store state information from the processor in a non-volatile memory device;
cause the processor to enter the idle state; and
monitor data transmitted to the processor for a signal that the processor is to return to the operating state.

16. The electronic device of claim 15, wherein the logic is to stop a system clock signal within the processor.

17. The electronic device of claim 15, wherein the logic detects the indication that the electronic device is to enter the idle state from an operating system comprising advanced configuration and power interface instructions.

18. The electronic device of claim 15, wherein the idle state comprises a suspend-to-ram state.

19. The electronic device of claim 15, wherein the logic is to stop a flow of current to one or more components of the electronic device in response to detecting the indication that the electronic device is entering the idle state.

20. The electronic device of claims 15, wherein the processor does not execute instructions during the idle state.

21. A system, comprising:
a processor; and
logic to:
determine that the processor cannot modify the operating state of the processor;
detect an indication that the electronic device is to enter an idle state;
store state information from the processor in a memory device; and
cause the processor to enter the idle state.

22. The system of claim 21, wherein the system comprises a storage device.
